(19) United States
(12) Patent Application Publication
(10) Pub. No.: US 2025/0222992 A1
(43) Pub. Date: Jul. 10, 2025

(54) RACK SYSTEM FOR TRUCKS

(71) Applicant: CDC America, Inc., Milford, MI (US)

(72) Inventor: George Huisman, Milford, MI (US)

(73) Assignee: CDC America, Inc., Milford, MI (US)

(21) Appl. No.: 19/010,581

(22) Filed: Jan. 6, 2025

Related U.S. Application Data
(60) Provisional application No. 63/617,479, filed on Jan. 4, 2024.

(51) Int. Cl. B62D 33/08

(52) U.S. Cl. CPC B62D 33/08

(57) ABSTRACT

A rack system for a truck is provided that includes a rail system. The rail system includes a first rail and a second rail, each bordering a bed of the truck. A first support structure and a second support structure are provided, each having at least one accessory attachment fixture provided thereon configured to couple at least one truck accessory thereto. Each cross member is configured to laterally extend between the first rail and the second rail, the first support structure and the second support structure are configured to engage with the rail system and at least the first support structure is configured to be slidably positioned within the rail system such that the first support structure abuts the second support structure in an unloaded configuration and is separated from the second support structure in a loaded configuration.

### RELATED APPLICATIONS

This application claims priority benefit of U Provisional Application Ser. No. 63/617,479 filed 4 Jan. 2024; the contents of which are hereby incorporated by reference.

### FIELD OF THE INVENTION

The present invention in general relates to a rack system for a pickup truck and in particular to a cargo rack for use with a pickup truck for securely carrying long items and that is configured for use with a variety of accessories for enhanced functionality.

### BACKGROUND OF THE INVENTION

Pickup truck racks are typically used for carrying cargo and large equipment in the back of a pickup truck. Typically, the items carried by such truck racks are long, cumbersome items that do not fit within the confines of the bed of the pickup truck, such as canoes, kayaks, lumber, ladders, etc.

Typical truck racks are intended to be mounted to a truck cargo area either within the truck bed, along the walls of the truck bed, or a combination thereof. Such racks are typically intended to be removed from the vehicle when not in use for carrying cargo so as to not interfere with the aerodynamics of the vehicle nor the field of vision of the driver. As these devices are bulky and cumbersome themselves, removal after each use and installation prior to each use requires substantial labor, often from at least two people. Such installation and removal also typically require standard or specialized tools that must be kept with the rack or located before installation and removal. Such typical truck racks also require being stored in a secure and clean location when not mounted on a vehicle, usually taking up valuable garage or shed space.

While truck racks that remain permanently mounted to a vehicle have been attempted such as those that include parts that nest within other parts of the rack or that nest within the cargo compartment of a pickup truck, these racks have proven disadvantageous in that they interfere with a driver's field of vision, interfere with the aerodynamics and therefore fuel efficiency of the vehicle, and/or take up valuable space within the cargo compartment of the vehicle.

Another drawback of typical truck racks is that they require two people to assist with loading and unloading the cargo onto and off of the rack owing in part to the spaced apart nature of the support structures of the rack, the overhead position of the support structures of the rack, and the long cumbersome nature of the typical items stored on such racks. Loading of an item onto and off of typical racks can be labor intensive, physically demanding, and potentially dangerous, requiring that the multiple users lift heavy or cumbersome objects above their heads for prolonged periods of time.

Advances have been made in developing permanently mounted truck racks that do not interfere with a driver's field of vision, that do not interfere with the aerodynamics and therefore fuel efficiency of the vehicle, that do not take up space within the cargo compartment of the vehicle, that are configured for safe and easy loading by a single user, such as disclosed in U.S. Pat. No. 11,052,828, the contents of which are incorporated by reference.

However, there exists a need to further enhance the functionality of such truck racks for activities including, but not limited to, camping, working, tailgating, hunting, and other recreational activities.

### SUMMARY OF THE INVENTION

A rack system for a truck is provided that includes a rail system. The rail system includes a first rail and a second rail, each rail having a first end and a second end, the second rail configured to be spaced apart from and positioned parallel to the first rail, the first rail and the second rail bordering a bed of the truck. A first support structure and a second support structure are provided, each having a first end and a second end and having a cross member having a first end and a second end, the first support structure and the second support structure each having at least one accessory attachment fixture provided thereon configured to couple at least one truck accessory thereto. Each cross member is configured to laterally extend between the first rail and the second rail, the first support structure and the second support structure are configured to engage with the rail system and at least the first support structure is configured to be slidably positioned within the rail system such that the first support structure abuts the second support structure in an unloaded configuration and is separated from the second support structure in a loaded configuration.

### BRIEF DESCRIPTION OF THE DRAWINGS

The present invention is further detailed with respect to the following drawings that are intended to show certain aspects of the present invention but should not be construed as a limit on the practice of the present invention.

FIG. 1 is a front perspective view of a cargo rack according to embodiments mounted on a pickup truck in a closed or unloaded configuration;

FIG. 2 is a front perspective view of the cargo rack of FIG. 1 in an open or loaded configuration;

FIG. 3 is a rear perspective view of a cargo rack according to embodiments mounted on a pickup truck in a closed or unloaded configuration;

FIG. 4 is a rear perspective view of the cargo rack of FIG. 3 in an open or loaded configuration;

FIG. 5 is a side view of a cargo rack according to embodiments mounted on a pickup truck in a closed or unloaded configuration;

FIG. 6 is a side view of the cargo rack of FIG. 5 in an open or loaded configuration;

FIG. 7 is a top view of a cargo rack according to embodiments mounted on a pickup truck in a closed or unloaded configuration;

FIG. 8 is a top view of the cargo rack of FIG. 7 in an open or loaded configuration;

FIG. 9A shows a hook accessory attachment fixture according to embodiments of the present invention;

FIG. 9B shows a hook and loop pair accessory attachment fixture according to embodiments of the present invention;

FIG. 9C shows a threaded hole and cooperating threaded fastener accessory attachment fixture according to embodiments of the present invention;

FIG. 9D shows a threaded post and cooperating nut accessory attachment fixture according to embodiments of the present invention;

FIG. 9E shows a cooperating snap post and snap cap accessory attachment fixture according to embodiments of the present invention;

FIG. 9F shows a clamp accessory attachment fixture according to embodiments of the present invention;

FIG. 9G shows a cooperating pair of magnets accessory attachment fixture according to embodiments of the present invention;

FIG. 10A shows a collapsible truck bed cap accessory in a deployed configuration according to embodiments of the present invention;

FIG. 10B shows a collapsible truck bed cap accessory in a stored configuration according to embodiments of the present invention;

FIG. 11 shows a modular surface structure accessory overlying support structures in an unloaded configuration according to embodiments of the present invention;

FIG. 12 shows a modular surface structure accessory overlying support structures in a loaded configuration and an awning accessory extending beyond the support structures in the unloaded configuration according to embodiments of the present invention;

FIG. 13 shows a modular surface structure accessory configured as a floor and a covered shelter space accessory supported thereon according to embodiments of the present invention;

FIG. 14 shows a shade canopy accessory extending from and a hammock accessory supported by the support structures in a loaded configuration according to embodiments of the present invention;

FIG. 15 shows a shade canopy accessory extending from the bed of the truck and the support structures in an unloaded configuration according to embodiments of the present invention;

FIG. 16 shows a modular surface structure accessory and an awning accessory extending from the support structures in a loaded configuration beyond the bed of the truck according to embodiments of the present invention;

FIG. 17 shows a rail system accessory being a modular surface structure coupled to a rail of the system and extending beyond the bed of the truck according to embodiments of the present invention;

FIG. 18 shows a rail system accessory being a pool liner coupled to the rails of the system according to embodiments of the present invention;

FIG. 19A shows a rail and rollers of an end of a support structure separated from one another according to embodiments of the present invention;

FIG. 19B shows rollers of the end of a support structure inserted within a rail according to embodiments of the present invention.

### DESCRIPTION OF THE INVENTION

The present invention has utility as a cargo rack system for use with a pickup truck for securely carrying long items while also providing accessories to enhance the functionality of the truck for activities including, but not limited to, camping, working, tailgating, hunting, and other recreational activities. The rack of the inventive system is configured to be permanently mounted to the vehicle without interfering with a driver's field of vision and without interfering with the aerodynamics and therefore fuel efficiency of the vehicle and is configured to not take up space within the cargo compartment of the vehicle and is configured for safe and easy loading by a single user. The inventive system additionally includes several accessory attachment fixtures provided on the truck rack for securing a variety of interchangeable accessories to the rack.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

Referring now to the figures, an inventive rack system 10 includes a rail system including a first rail 12 and a second rail 14. According to embodiments, the rails 12, 14 are formed of aluminum or another high strength and light weight material. Each rail 12, 14 has a first end 16, 16′ and a second end 18, 18′, respectively. The rails 12, 14 are configured to be spaced apart from one another and positioned in parallel. According to embodiments, the rail system is configured to be attached to the bed B of a truck or, as shown in the figures, to walls W that are positioned around the bed B of a truck and that define the cargo space of a truck. As shown in the figures, the first end 16, 16′ of each of the rails 12, 14 is positioned near the cab C at the front on the truck, while the second end 18, 18′ of each of the rails 12, 14 is positioned near a tailgate or liftgate G at the rear of the truck T.

The rack system 10 also includes a first support structure 20 and a second support structure 22. According to embodiments the support structures 20, 22 are formed of aluminum, thermoset material, thermoplastic material, or a combination thereof such that the rack system 10 is of a sufficient strength for holding cargo while also being light weight to not degrade the fuel efficiency of the truck. According to embodiments, the support structures 20, 22 are formed of sheet molding compound (SMC), which according to some embodiments has a high gloss surface finish. As used herein, the term “high gloss surface” refers to a surface having minimal perceptible surface defects when visually inspected for about three seconds from about 24-28 inches from the viewer and normal to the part surface +/−90 degrees in a well-lit area. That is, the term “high gloss surface” refers to a surface capable of being painted and accepted as a “Class A” autobody part. This is commonly measured by ASTM D523. In the automotive industry, a Class A surface is a surface a consumer can see without functioning the vehicle (e.g., opening the hood or decklid), while a Class A surface finish generally refers to painted outer panels and specifically to the distinctness of image (DOI) and gloss level on the part. It is appreciated that a surface layer may be subjected to sanding, trimming, and priming prior to receiving a paint coating that imparts high gloss, yet must retain dimensionality and adhesion uniformity to primer and paint so as to achieve a high gloss finish. According to embodiments, the support structures 20, 22 have the same surface finish and paint color as the rest of the vehicle body, providing a unique and streamlined look for the rack system 10 and the vehicle. Each support structure 20, 22 has a first end 24, 24′ and a second end 26, 26′. Each support structure 20, 22 also includes a cross member 28, 28′ having a first end 30, 30′ and a second end 32, 32′. The cross members 28, 28′ have a generally rectangular cross section. According to embodiments, the cross members 28, 28′ are smooth, allowing air to pass over the cross members 28, 28′ with minimal turbulence. As shown in the figures, each cross member 28, 28′ of each of the first support structure 20 and second support structure 22 is configured to laterally extend between the first rail 12 and the second rail 14, when the ends 24, 24′, 26, 26′ of the support structures 20, 22 are engaged with the rails 12, 14.

According to embodiments, the support structures 20, 22 each also include a first support member 34, 34′ extending from the first end 30, 30′ of each cross member 28, 28′ to the first end 24, 24′ of each support structure 20, 22 and a second support member 36, 36′ extending from the second end 32, 32′ of each cross member 28, 28′ to the second end 26, 26′ of each support structure 20, 22. According to embodiments, the support structures 20, 22 with the support members 34, 34′, 36, 36′ and the cross member 28, 28′ are generally C-shaped. The support members 34, 34′, 36, 36′ each have a generally rectangular cross section. According to embodiments, the support members 34, 34′, 36, 36′ are smooth, allowing air to pass over the cross members 28, 28′ with minimal turbulence. As shown in the figures, the support members 34, 34′, 36, 36′ elevate the cross members 28, 28′ of the support structures 20, 22 above the rails 12, 14. According to embodiments, the support members 34, 34′, 36, 36′ are long enough to elevate the cross members 28, 28′ to approximately the height of the roof of the cab C, such that a driver's view through a rear window of the truck is unobstructed when the rack 10 is installed on the truck T. It will be understood that the support members 34, 34′, 36, 36′ and the cross members 28, 28′ may be used independently of one another based on the use requirements of a user, making the system 10 modular and extremely versatile.

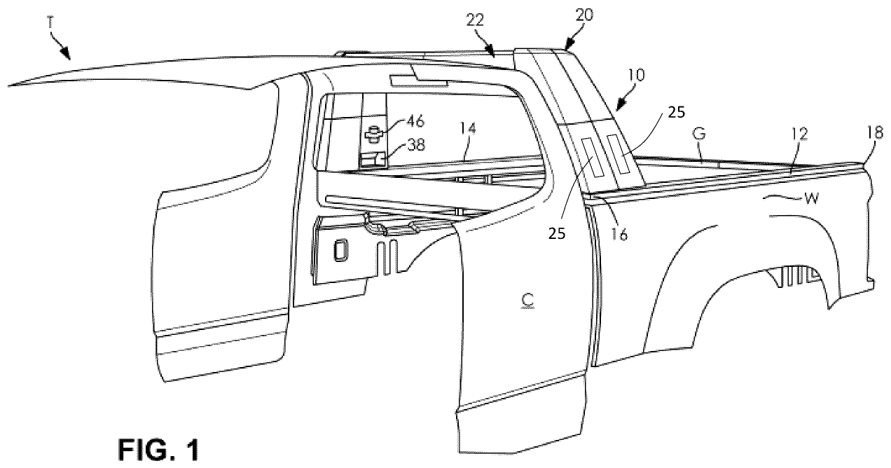

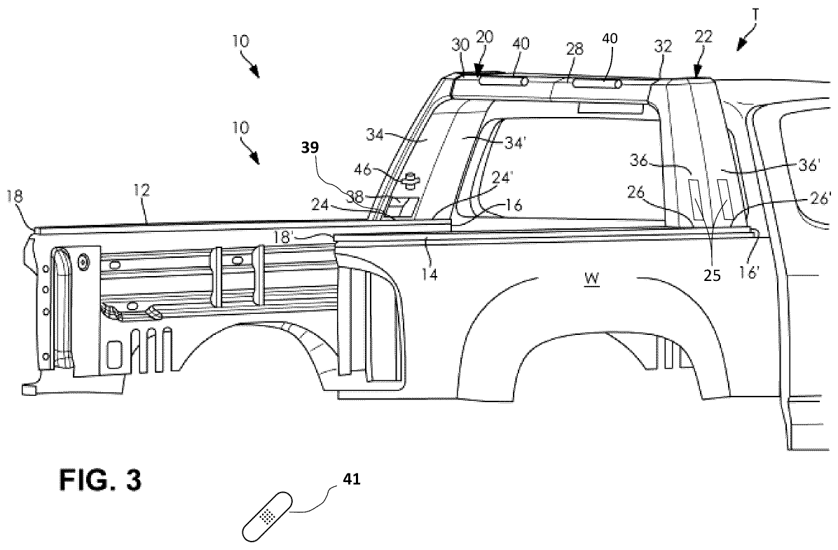

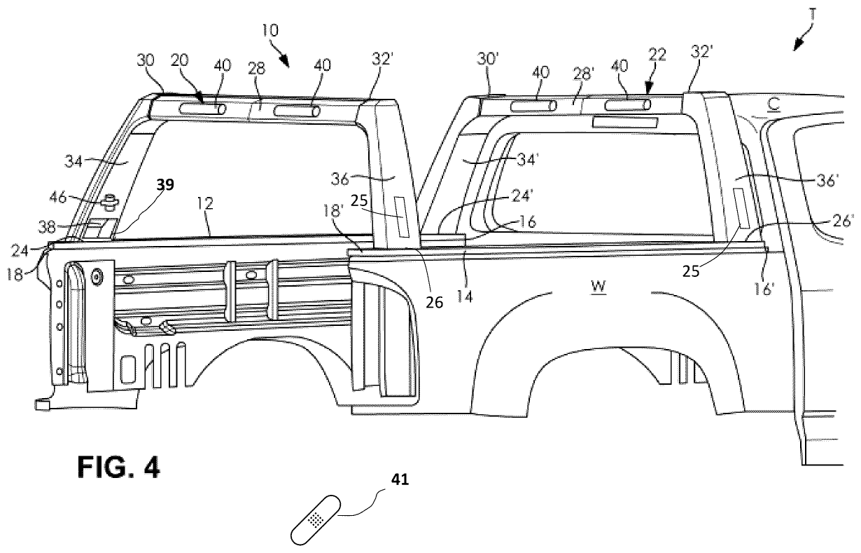

According to embodiments, the support members 34, 34′, 36, 36′ are height adjustable. Therefore, each of the support members 34, 34′, 36, 36′ may include at least two sections, as shown in FIGS. 1, 2, 7, and 8, that telescope relative to one another. In the Figures, the support members 34, 34′, 36, 36′ are shown fully extended, however, the two sections of each support member 34, 34′, 36, 36′ are shown. According to such embodiments, the height of the support members 34, 34′, 36, 36′ is manually or electronically adjusted. Electronic movement control is exerted by one or more motors. In still other inventive embodiments, the slide motion of the support member 22 is controlled by one or more motors 39 depicted in FIGS. 3 and 4. The motor 39 being mechanically coupled to rail 12 to selectively move a support structure 20 or 22 along the length the truck bed. In still other inventive embodiments, like motors 39 are placed in opposing support members to drive both in concert along the rails 12 and 14. It has been observed that heavy or uneven loads induce differential rates of sliding that in extreme instances can lead cause slide stopping buckling. In still other inventive. The height of the support members 34, 34′, 36, 36′ can be adjusted by way of telescoping portions of the support members 34, 34′, 36, 36′ that lock into position relative to one another, by way of pneumatic cylinders, by an internal ratcheting or gear system, or the like. In still other inventive embodiments, a user remote control 41 is provided for wireless control of at least one of the height of the support members 34, 34′, 36, 36′; or the slide position of the support structure 22. As a result, a single user is able to stabilize a load, such as a kayak while the inventive system moves to support the load for transport, all the while the load being controlled from a catastrophic dislodgement.

As shown in the figures, the support structures 20, 22 are installed with the rail system such that the second support structure 22 is at least initially positioned at the first ends 16, 16′ of the rails 12, 14 near the cab C of the truck T. The first support structure 20 is positioned behind the second support structure 22 when installed on the rails 12, 14.

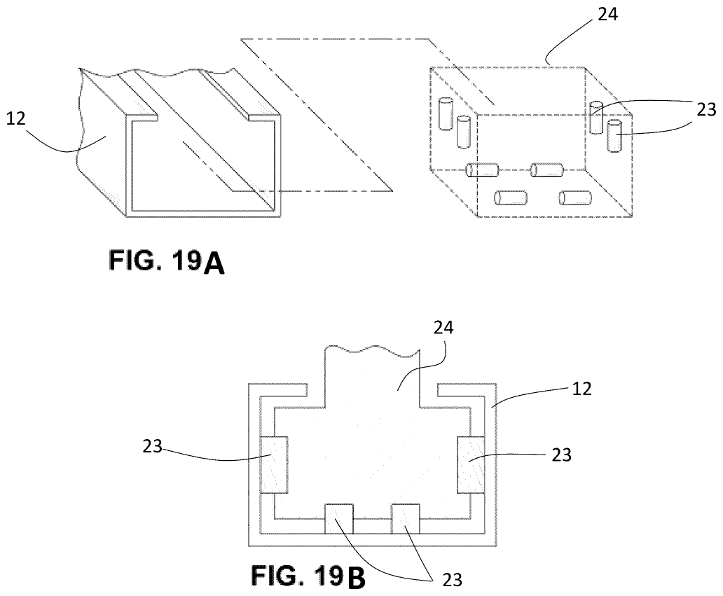

The first ends 24, 24′ of the support structures 20, 22 are configured to engage with the first rail 12 and the second ends 26, 26′ of the support structures 20, 22 are configured to engage with the second rail 14. The ends 24, 24′, 26, 26′ of the support structures 20, 22 have a shape that corresponds with the shape of the rails 12, 14. According to embodiments, the rails 12, 14 define an internal channel that is for example U-shaped, while the ends 24, 24′, 26, 26′ of the support structures have a corresponding inverted T-shape that fits within the U-shaped channel of the rails 12, 14, as shown in FIGS. 19A and 19B. According to embodiments, the rails 12, 14 define external grooves, while the ends 24, 24′, 26, 26′ of the support structures are shaped such that they snap onto the rails 12, 14 with a portion extending and locking into the external grooves of the rails 12, 14. According to embodiments, the ends 24, 24′, 26, 26′ of the support structures each have a set of rollers 23 attached thereto that are configured to engage with the rails 12, 14 for slidably positioning the support structures 20, 22 within the rails 12, 14. According to embodiments, each set of rollers 23 runs along a bottom of one of the rails 12, 14 and along a first side and second side of one of the rails to form a U-shape inside the rail 12, 14. For example, each set of rollers may include at least three rollers, wherein a first of the three rollers is configured to be positioned within one of the rails 12, 14, a second of the three rollers is configured to be positioned along a first side of one of the rails 12, 14, and a third of the three rollers is configured to be positioned along a second side of one of the rails 12, 14. One of ordinary skill in the art will appreciate that the ends 24, 24′, 26, 26′ of the support structures 20, 22 may engage with the rails 12, 14 in a number of other ways provided that the ends 24, 24′, 26, 26′ are secured to the rails 12, 14 and the ends 24, 24′, 26, 26′ slidable along the rails 12, 14.

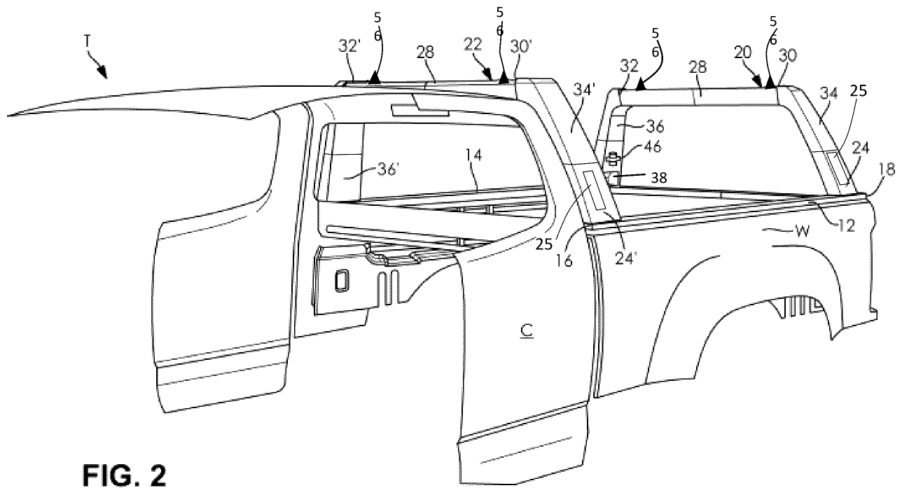

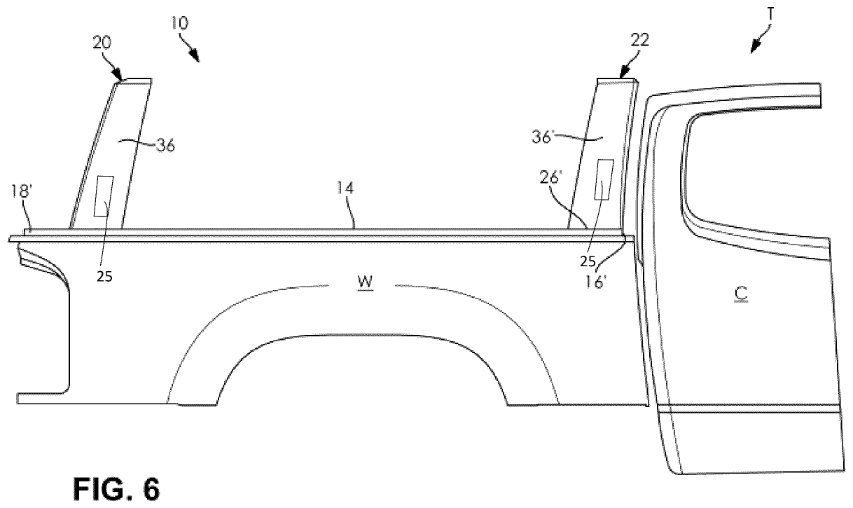

Furthermore, when the support structures 20, 22 are installed with the rails 12, 14, at least the first support structure 20 is slidable within the rail system. That is, the position of at least the first support structure 20, and according to embodiments both support structures 20, 22, relative to the length of the rails 12, 14 is slidably positionable within the rail system. Given the slidable nature of at least the first support structure 20 within the rail system, the first support structure 20 is configured to slide along the length of the rails 12, 14 between the second ends 18, 18′ of the rails 12, 14 and the first ends 16, 16′ of the rails 12, 14 to a position where the first support structure 20 abuts the second support structure 22. Accordingly, the first support structure 20 is positionable along the length of the rails 12, 14 and is therefore capable of being positioned in a closed or unloaded configuration in which the first support structure 20 abuts the second support structure 22, preferably near the first ends 16, 16′ of the rails 12, 14 near the cab C, such as that shown in FIGS. 1, 3, 5, and 7, and an open or loaded configuration in which the first support structure 20 is separated from the second support structure 22, such as that shown in FIGS. 2, 4, 6, and 8. According to embodiments the second support structure 22 is also slidable along the rails 12, 14.

According to embodiments, at least the first slidable support structure 20 and optionally the second slidable support structure 22 includes a lock mechanism 25 near its first end 24, 24′ and second end 26, 26′. The lock mechanisms 25 are configured to secure the position of the support structure 20, 22 relative to the rails 12, 14 once the support structure 20, 22 has been slid into its desired position along the length of the rails 12, 14. According to embodiments, the locking mechanism 25 is a handled clamp or brake (as shown in FIGS. 1-8), a cotter key or bolt used in conjunction with through holes in the support structures 20, 22 and along the length of the rails 12, 14, a spring button lock on the support structures 20, 22 used in conjunction with through holes along the length of the rails 12, 14, or any other suitable locking mechanism. According to embodiments, the lock mechanism 25 is configured to selectively lift the bottom rollers 23 and press the inverted T-shaped end 24, 24′, 26, 26′ into the rail 12, 14 using a friction fits against, for example the top lip of the rail 12, 14. According to embodiments, the lock mechanisms 25 are configured to be flush with the support members 34, 34′, 36, 36′ of the support structures 20, 22 when the lock mechanisms 25 are engaged in a locked position securing the position of the support structure 20, 22 relative to the rails 12, 14. The lock mechanisms 25 are further configured to be disengaged, or example by pulling on a handle of the lock mechanism 25 away from the support members 34, 34′, 36, 36′ of the support structures 20, 22, allowing the support structure 20, 22 to be slid into its desired position along the length of the rails 12, 14. The, the engage the lock mechanisms 25 to secure the position of the support structure 20, 22 relative to the rails 12, 14 in the desired position, the lock mechanisms 25 are each returned to a position that is generally flush with the support members 34, 34′, 36, 36′. It will be noted that other positions of the lock mechanisms 25 are contemplated, but a position near the ends of the support members 34, 34′, 36, 36′ ensure that a user standing on the ground or standing in the truck bed is able to reach and access the lock mechanisms and the position of the lock mechanisms being generally flush with the support members 34, 34′, 36, 36′ contributes to the aerodynamics of the vehicle.

According to embodiments, the support structures 20, 22 are slidably positioned along the rails 12, 14 by electronic controls, which according to embodiments are controlled by a user remote. According to embodiments, the electronic controls include a number of preset positions for the support structures 20, 22. For example, the electronic controls can direct the support structures 20, 22 into an unloaded present position in which both support structures move to their fully extended heights and move to the first end 16, 16′ of the rails 12, 14 near the cab C. The electronic controls can include yet another preset position such as a loaded preset position in which the support structures are controlled into a maximally separated position wherein the first support structure 20 is positioned near the second end 18, 18′ of the rails 12, 14 while the second support structure 22 is positioned near the first end 16, 16′ of the rails 12, 14. A number of intermediate preset positions may also be included in the electronic controls. For example, a loading preset position may direct the first support structure 20 a lowered height at the second end 18, 18′ of the rails 12, 14 and/or the second support structure 22 to a position at the center of the rails 12, 14 to facilitate the loading of cargo onto the rack 10. According to embodiments, the preset positions are pre-programmed into a user remote control. According to embodiments, additional preset positions may be programmed into the remote control by a user based on the user's preferences.

According to embodiments the rack system 10 is further equipped with devices that further facilitate easy loading and securing of cargo onto the rack system 10 by a single user. As shown in FIGS. 3, 4, 7, and 8, embodiments of the rack 10 are equipped with a roller 40 on each of the cross members 28, 28′. The rollers 40 allow the cargo to be rolled along the support structures 20, 22 once the cargo is on the support structures 20, 22, thereby alleviating the strength required to push and pull the cargo into position on and off the support structures 20, 22.

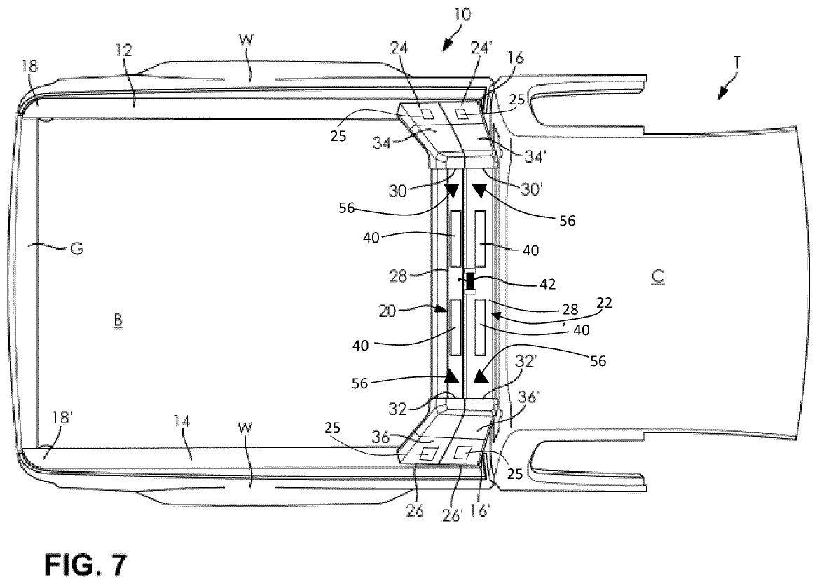

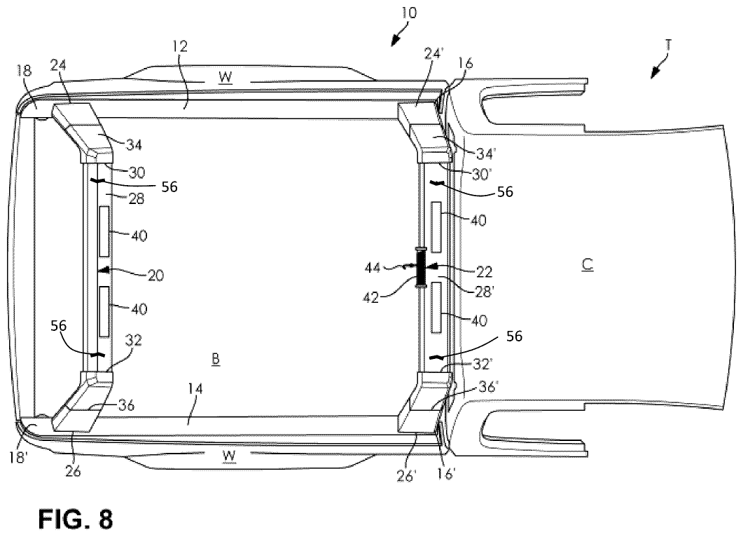

As shown in the embodiments of FIGS. 7 and 8, the second support structure 22 is equipped with a winch 42, for example fixed to the cross member 28′. The winch includes a winch strap 44 that can be extended from the cross member 28′ of the second support structure 22 toward the liftgate or tailgate G of the truck T. The winch strap 44 can then be secured to the cargo to be loaded. The winch strap can then be retracted by the winch, thereby pulling the cargo toward the second support structure 22 and the cab C of the truck T.

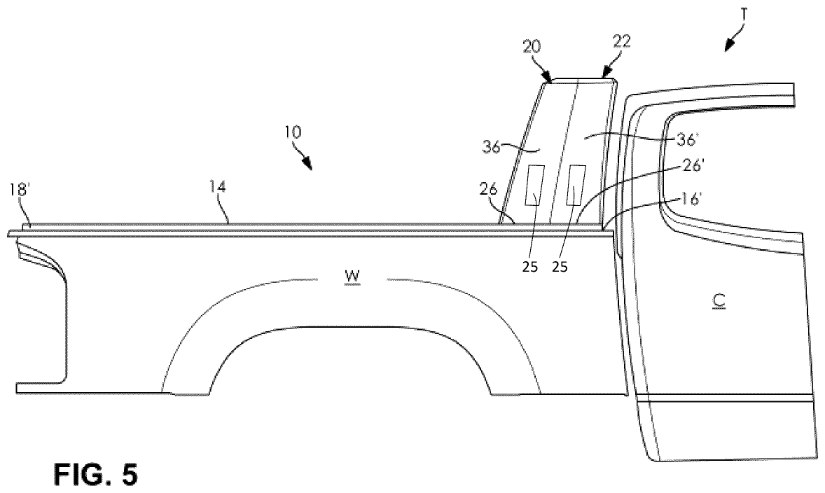

According to embodiments, each of the support structures 20, 22 includes at least one tie down strap 46 or bungie cord connected thereto at a first end of each tie down strap or bungie cord. As shown in FIGS. 1-4, the tie down straps or bungie cords 46 can be provided on retractable coils on the inside surface of any of the support members 34, 34′, 36, 36′. The tie down straps or bungie cords are extendable from each of the support structures 20, 22 and are configured to securely tie cargo to the support structures 20, 22 of the rack. This feature ensures that a user always has the equipment necessary to securely tie cargo to the rack, thereby eliminating the need to find the necessary equipment of plan ahead before use. The embodiments of FIGS. 5-8 may also include a tie down strap 46 or bungie cord, however, these features are not visible in the perspective of FIGS. 5-8.

As shown in FIGS. 1-4 in embodiments, one or both of the support structures 20, 22 include a plurality of tie down points 38 that can be used to tie, hook, or otherwise secure tie down straps or bungie cords to. According to embodiments, the tie down points 38 are defined in the support members 34, 34′, 36, 36′ of the support structures 20, 22. The embodiments of FIGS. 5-8 may also include a tie down points 38, however, these features are not visible in the perspective of FIGS. 5-8.

As shown in the embodiments of FIGS. 1, 2, 7, and 8, the rack 10 includes a plurality of slide stops 56. The slide stops 56 are positioned on the upper surface of the cross members 28, 28′ and are configured to extend therefrom. As shown in FIGS. 1 and 7, when the support structures 20, 22 are in a closed or unloaded position near the first ends 16, 16′ of the rails 12, 14, the slide stops are configured to be folded down and flush with the upper surface of the cross members 28, 28. As shown in FIGS. 2 and 8, when the support structures 20, 22 are in a loaded position in which the first support structure 20 is positioned near the second end 18, 18′ of the rails 12, 14 and the second support structure 22 is positioned near the first end 16, 16′ of the rails 12, 14, the slide stops 56 are configured to be flipped upward to extend from the cross members 28, 28. The slide stops 56 are useful for preventing cargo from sliding off the ends of the support structures 20, 22. The embodiments of FIGS. 3-6 may also include slide stops, however, these features are not visible in the perspective of FIGS. 3-6 or not is use in those figures.

Given the features of the inventive rack system 10, the rack system 10 is suitable for permanent installation on a truck. That is, because the rails 12, 14 can be mounted to the walls W of the truck T, the rack system 10 does not take up valuable cargo space within the bed B of the truck. Additionally, because the support structures 20, 22 are slidable within the rails 12, 14, the support structures can be positioned near the first ends 16, 16′ of the rails 12, 14 directly behind the cab C of the truck T, which during non-use of the rack can act as an air foil on the back of the cab C of the truck to decrease drag and improve aerodynamics of the truck without impairing the rear view of the driver. Furthermore, the features of the inventive rack system enable easy and safe loading and unloading of cargo from the rack system 10 by a single user.

To further enhance the functionality of the truck rack system 10, for activities including, but not limited to, camping, working with tools, tailgating, hunting, and other recreational activities, the support structures 20, 22 each have at least one accessory attachment fixture 60 provided thereon. Each accessory attachment fixture 60 is configured to couple to a corresponding attachment fixture 60′ provided on at least one truck accessory 70 of the rack system 10 in order to secure the truck accessory 70 to the support structures 20, 22 and/or rails 12, 14. According to embodiments, anywhere from 1 to 1,000 accessory attachment fixtures 60 may be provided on the support structures 20, 22 and the rails 12, 14; however, not all accessory attachment fixtures 60 are required to have a corresponding cooperating fixture 60′ for every accessory 70 utilized. Instead, the placement of the accessory attachment fixtures 60 on the support structures 20, 22 and/or rails 12, 14 are intended to provide versatility and configurability of the various accessories 70 of the system. According to embodiments, the accessory attachment fixtures 60 are positionable, for example, at least some of the accessory attachment fixtures 60 slidably engage with at least one of the rails 12, 14.

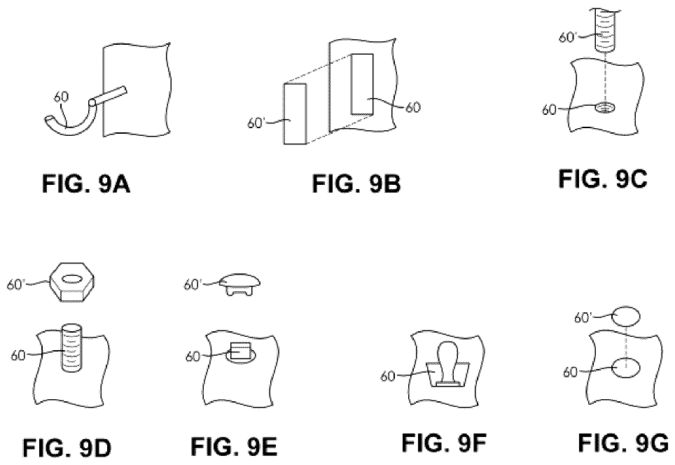

As shown in FIGS. 9A-G, the at least one accessory attachment fixture 60 provided on either of the support structures 20, 22 or rails 12, 14 are each independently half of a cooperating fastening pair, such as a hook (FIG. 9A) and cooperating gromet, a hook and loop pair (FIG. 9B), a threaded hole and cooperating threaded fastener (FIG. 9C), a threaded post and cooperating nut (FIG. 9D), a cooperating snap post and snap cap (FIG. 9E), a clamp (FIG. 9F), or single magnet or a cooperating pair of magnets (FIG. 9G). It will be understood that other accessory attachment fixtures 60, 60′ are also contemplated provided that they function to secure at least a portion of an accessory 70 to the support structures 20, 22 or the rails 12, 14. It will be further understood that the cooperating portions of the accessory attachment fixtures 60, 60′ can be provided on either the support structure and/or rails and/or the accessories 70 themselves provided the cooperating pairs are able to align with one another and function to secure at least a portion of an accessory 70 to the support structures 20, 22 or the rails 12, 14. According to embodiments, the accessory attachment fixtures 60 of the support structures 20, 22 are each independently provided on the cross member 28, 28′, on any of the support members 34, 34′, 36, 36′ of the support structures 20, 22, or the rails 12, 14.

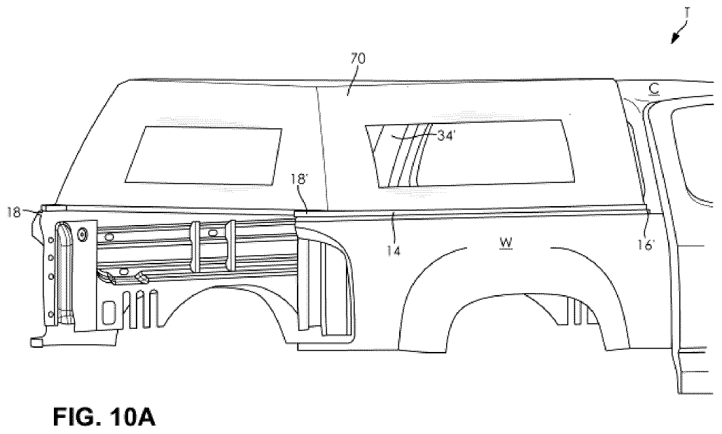

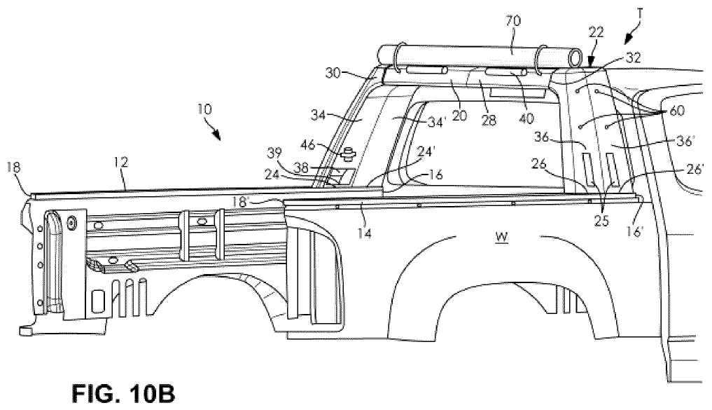

According to embodiments, an accessory 70 of the rack system 10 is a collapsible truck bed cap, as shown in FIGS. 10A and 10B in a deployed configuration and a stored configuration, respectively. The collapsible truck bed cap accessory 70 includes a plurality of accessory attachment fixtures 60′ that are configured to couple to the accessory attachment fixtures 60 of the support structures 20, 22 and the rails 12, 14 and is configured to cover the bed of the truck when the first support structure 20 is separated from the second support structure 22 in the loaded configuration. According to embodiments, the collapsible truck bed cap accessory 70 is formed of a fabric material so that it is flexible and able to be rolled or folded up when not in use. According to embodiments, the fabric is treated with a water resistant or waterproof material so that the contents of the truck bed remain dry when covered with the collapsible truck bed cap accessory 70. According to embodiments, the collapsible truck bed cap accessory 70 can stay attached to the support structures 20, 22 when the support structures 20, 22 are moved together into the unloaded configuration and the collapsible truck bed cap accessory 70 just collapses onto itself and may be secured to the support structures 20, 22 to avoid blocking the view of a driver. According to other embodiments, the collapsible truck bed cap 70 is configured to be rolled-up and secured to at least one of the support structures 20, 22 when in the unloaded configuration.

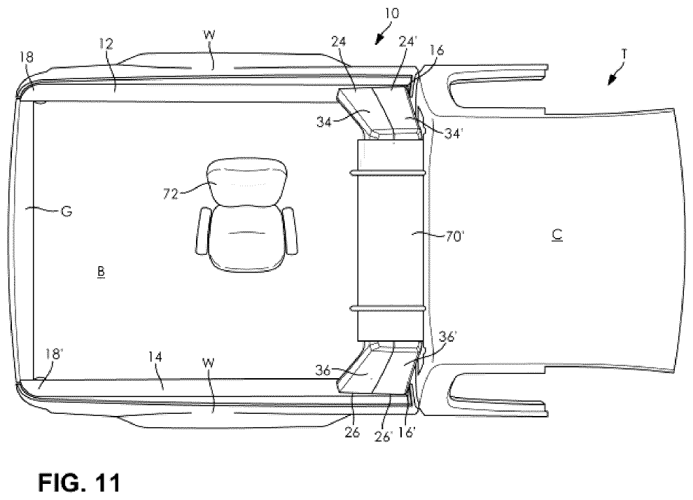

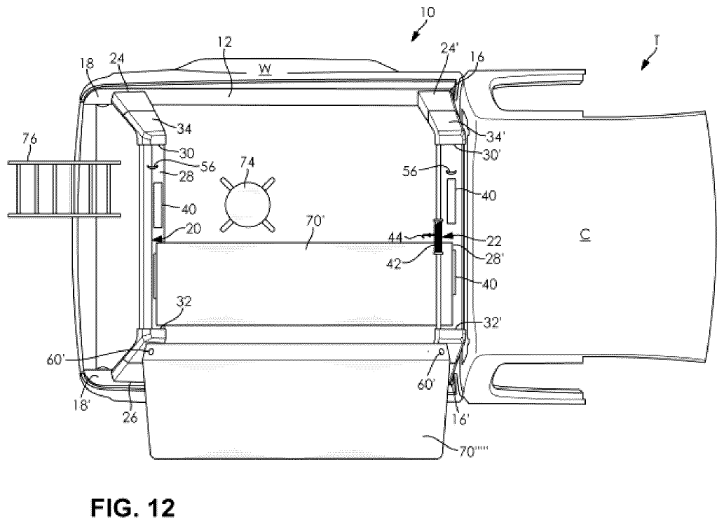

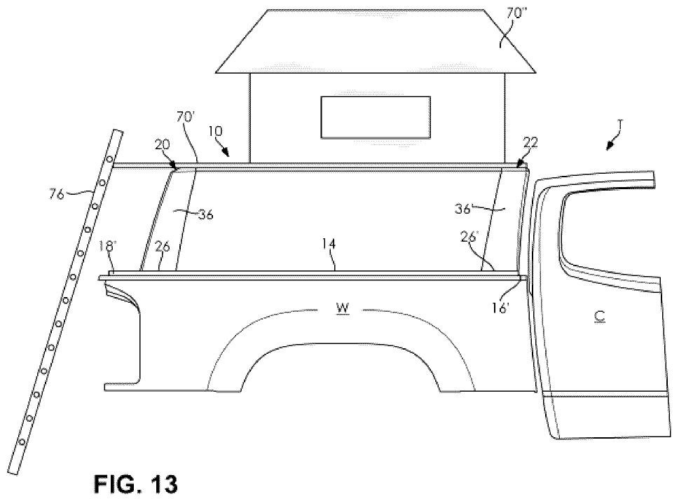

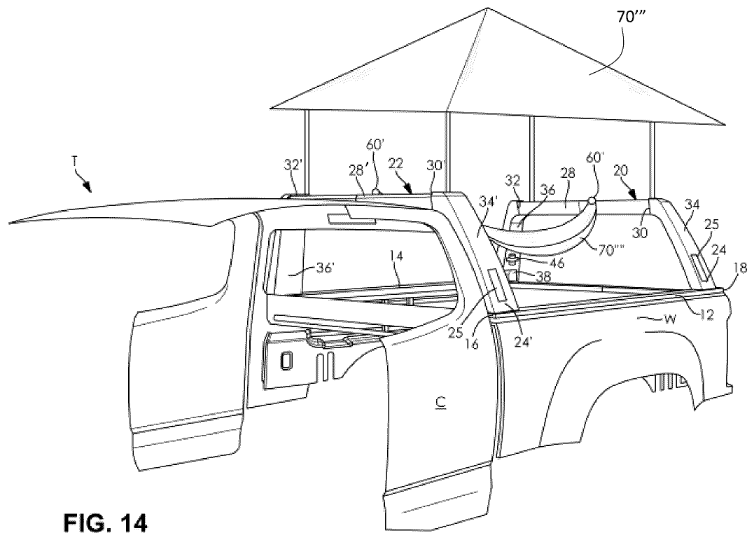

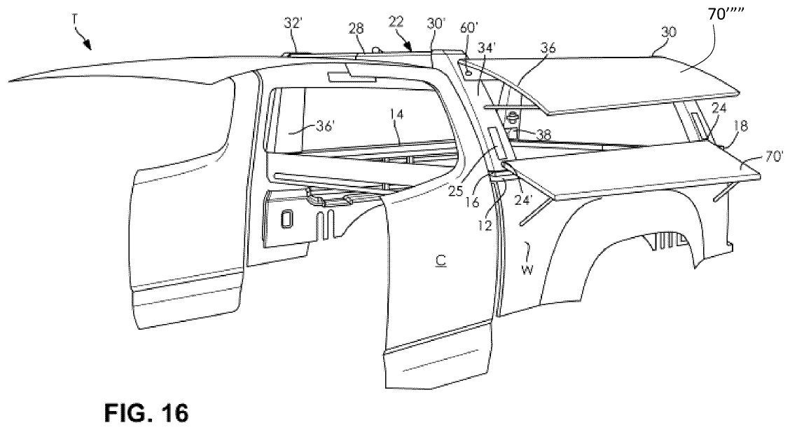

According to embodiments, an accessory 70′ of the rack system 10 is a modular surface structure, as shown in FIGS. 11-13. The modular surface structure 70′ includes a plurality of accessory attachment fixtures 60′ that are configured to couple to the accessory attachment fixtures 60 of the support structures 20, 22 and/or the rails 12, 14. According to embodiments, the modular surface structure 70′ is configured to overlie at least a portion of the cross members 28, 28′ of the support structures 20, 22 for use as a countertop, a work surface, a tabletop, or a floor. The modular surface structure 70′ is able to be used when the support structures 20, 22 are in any of the loaded configuration, the unloaded configuration, or some position therebetween. According to embodiments, the modular surface structure 70′ is formed of multiple modular pieces that fit together with one another to for the size and shape of a surface that a user desires for a particular application. As shown in FIG. 11, the modular surface structure 70′ can be attached to the accessory attachment fixtures 60 when the support structures 20, 22 are in the unloaded configuration near the cab C of the truck in order to provide a tabletop. As shown in FIG. 11, the system 10 additionally includes a chair 72 or stool configured to be supported by the bed of the truck for use with the tabletop. As shown in FIG. 12, the modular surface structure 70′ can be attached to the accessory attachment fixtures 60 when the support structures 20, 22 are in the loaded configuration spaced apart from one another in order to provide a countertop. As shown in FIG. 12, the system 10 additionally includes a stool 74 configured to be supported by the bed of the truck for use with the countertop. According to embodiments, the height of the modular surface structure 70′ relative to the bed B of the truck can be adjusted up and down by adjusting the height of the support members 34, 34′, 36, 36′ of the support structures 20, 22. As shown in FIG. 13 the modular surface structure 70′ can also be used as a floor meaning that a user is able to not only use the surface 70′ as a table top or countertop for objects, but the user may also stand, lay, or sit upon the modular surface structure 70′. The modular surface structure 70′ can cover all or only a portion of the bed B of the truck. According to embodiments, the system 10 additionally includes a ladder 76 that extends from the ground, i.e. surface upon which tires of the truck are supported, to the bed B of the truck and/or to the level of modular surface structure 70′ in order to enable a user to easily climb into the bed B of the truck or onto the floor. According to embodiments, the ladder 76 is height adjustable and/or may be separated into at least two ladder components. According to embodiments, such as that shown in FIG. 16, the modular surface 70′ is configured to extend between the support structures 20, 22 in the loaded configuration and extend beyond the bed of the truck such that the modular surface is adapted to be used as a countertop, a work surface, or a tabletop outside of the bed of the truck, for example when a user is positioned on the ground.

According to embodiments, an accessory 70″ of the rack system 10 is a covered shelter space, as shown in FIG. 13. The covered shelter space 70″ includes a plurality of accessory attachment fixtures 60′ that are configured to couple to the accessory attachment fixtures 60 of the support structures 20, 22 and/or the rails 12, 14. The shelter space 70″ may be used as a primary accessory or as an additional accessory in addition to another accessory. For example, as shown in FIG. 13, the covered shelter space 70″ is used in conjunction with a modular surface structure 70′ that has been configured as a floor overlying the bed B of the truck. According to embodiments, the shelter space accessory 70″ includes a canopy that extends up from either the bed B of the truck or from the surface of the modular surface structure 70′ when configured as a floor. The canopy includes a roof and/or walls. According to embodiments, the covered shelter space 70″ is a camping tent or a hunting blind.

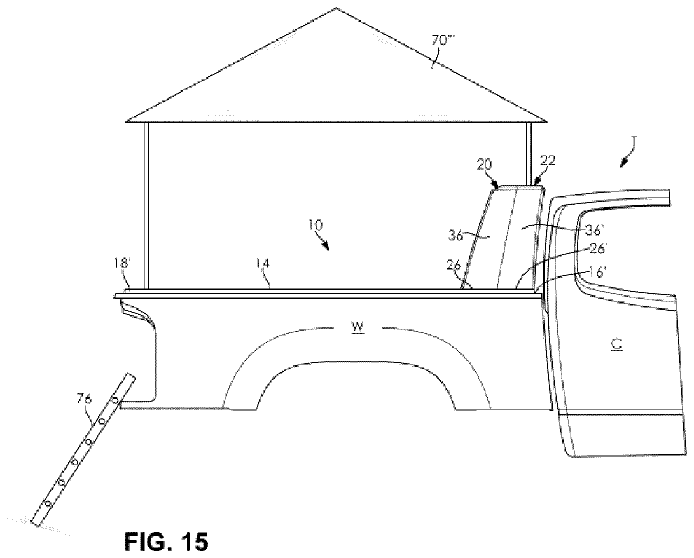

According to embodiments, an accessory 70′″ of the rack system 10 is a shade canopy, as shown in FIGS. 14 and 15. The shade canopy 70′″ includes a plurality of accessory attachment fixtures 60′ that are configured to couple to the accessory attachment fixtures 60 of the support structures 20, 22 and/or the rails 12, 14. The shade canopy 70′″ is configured to extend up from the support structures 20, 22 and/or the bed B of the truck to provide a covered space over the bed B of the truck when the support structures 20, 22 are in either of the loaded configuration or the unloaded configuration.

According to embodiments, an accessory 70″ of the rack system 10 is hammock, as shown in FIG. 14. The hammock 70″ includes a plurality of accessory attachment fixtures 60′ that are configured to couple to the accessory attachment fixtures 60 of the support structures 20, 22. The hammock 70″ is configured to extend between the first support structure 20 and the second support structure 22 over the bed of the truck when said the support structures are in the loaded configuration.

According to embodiments, an accessory 70′″ of the rack system 10 is an awning, as shown in FIGS. 12 and 16. The awning 70′″″ includes a plurality of accessory attachment fixtures 60′ that are configured to couple to the accessory attachment fixtures 60 of the support structures 20, 22 when the support structures 20, 22 are in the loaded or unloaded configuration. As shown in FIG. 15, the awning 70′″″ extends between the support structures 20, 22 in the loaded configuration and extends beyond the bed of the truck.

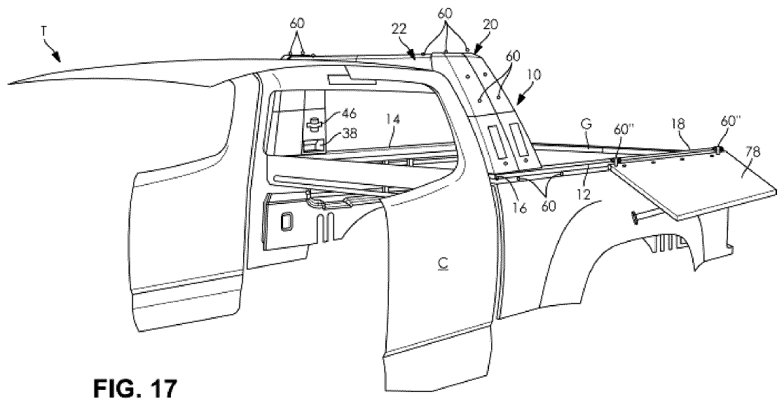

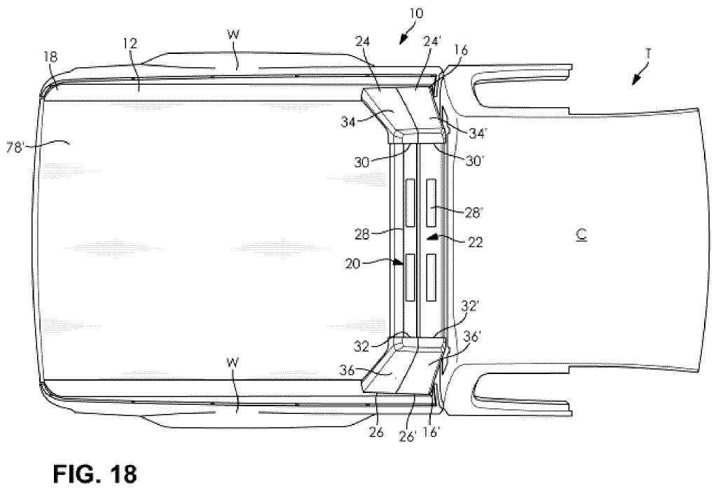

According to embodiments, the rack system 10 additionally includes at least one rail system accessory 78 that is configured to couple to at least one of the rails 12, 14 via at least one rail accessory attachment fixture 60″. According to embodiments, the rail system accessory 78 includes at least one rail accessory attachment fixture 60″ that is configured to slidably engage with at least one of the rails 12, 14 in order to be positioned along the length thereof. As shown in FIG. 17, the rail system accessory 78 is a modular surface that is configured to extend beyond the bed of the truck for use as a countertop, a work surface, or a tabletop from the ground surface. According to embodiments, such as that shown in FIG. 18, the rail system accessory 78′ is a pool liner that is configured to line the bed of the truck and to retain water therein.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A rack system for a truck comprising:
a rail system comprising a first rail and a second rail, each rail having a first end and a second end, the second rail configured to be spaced apart from and positioned parallel to the first rail, the first rail and the second rail bordering a bed of the truck; and
a first support structure and a second support structure and each having a first end and a second end and comprising a cross member having a first end and a second end, said first support structure and said second support structure each having at least one accessory attachment fixture provided thereon configured to couple at least one truck accessory thereto, each cross member configured to laterally extend between said first rail and said second rail, wherein said first support structure and said second support structure are configured to engage with said rail system and wherein at least said first support structure is configured to be slidably positioned within said rail system such that said first support structure abuts said second support structure in an unloaded configuration and is separated from said second support structure in a loaded configuration.

2. The rack system of claim 1 wherein the first rail and the second rail are configured to be attached to opposite sides or opposite walls of the bed of the truck.

3. The rack system of claim 1 wherein said a first rail and said second rail are formed of aluminum.

4. The rack system of claim 1 wherein said first support structure and said second support structure are formed of sheet molding composition (SMC) that has exterior vehicle surface finish.

5. The rack system of claim 4 wherein the SMC material of said first support structure and said second support structure is configured to be painted to match a color of the truck.

6. The rack system of claim 1 wherein the at least one accessory attachment fixture of said first support structure and said second support structure are each independently at least one of hook and loop, a snap, a threaded hole, a threaded post, a clamp, a hook, or a magnet.

7. The rack system of claim 1 wherein the at least one accessory attachment fixture of said first support structure and said second support structure are each independently provided on the cross member, on a first side of said first support structure or said second support structure, or on a second side of said first support structure or said second support structure.

8. The rack system of claim 1 wherein the at least one accessory attachment fixture of said first support structure and said second support structure each independently include a plurality of accessory attachment fixtures.

9. The rack system of claim 1 further comprising a plurality of additional accessory attachment fixtures provided on at least one of the first rail and the second rail.

10. The rack system of claim 1 wherein the at least one truck accessory is a collapsible truck bed cap configured to couple to the at least one accessory attachment fixture of said first support structure and said second support structure and configured to cover the bed of the truck when said first support structure is separated from said second support structure in the loaded configuration, and optionally, the collapsible truck bed cap is configured to be rolled-up and secured to at least one of said first support structure and said second support structure when in the unloaded configuration.

11. The rack system of claim 1 wherein the at least one truck accessory is a modular surface structure configured to couple to the at least one accessory attachment fixture of said first support structure and said second support structure and configured to overlie at least a portion of the cross members of said first support structure and said second support structure and wherein the modular surface is adapted to be used as a countertop, a work surface, a tabletop, or a floor, and optionally, the modular surface is configured to overlie at least the portion of the cross members of said first support structure and said second support structure when the support structures are in the loaded configuration or the modular surface is used as a countertop or table or floor.

12. The rack system of claim 1 wherein the at least one truck accessory is a modular surface structure configured to couple to the at least one accessory attachment fixture of said first support structure and said second support structure and configured to overlie at least a portion of the cross members of said first support structure and said second support structure and wherein the modular surface is used as a floor, the rack system further comprises a canopy as a second truck accessory, the canopy configured to couple to and extend up from the floor and provide a covered shelter space over the floor, and optionally, the covered shelter space is a camping tent or a hunting blind.

13. The rack system of claim 1 wherein the at least one truck accessory is: a shade canopy or a hammock configured to couple to the at least one accessory attachment fixture of said first support structure and said second support structure and configured to extend between said first support structure and said second support structure over the bed of the truck when said first support structure and said second support structure are in the loaded configuration; or an awning configured to couple to the at least one accessory attachment fixture of said first support structure and said second support structure and configured to extend between said first support structure and said second support structure in the loaded configuration and extend beyond the bed of the truck.

14. The rack system of claim 1 further comprising at least one rail system accessory that is configured to couple to at least one of the first rail and the second rail of said rail system, and optionally, the at least one rail system accessory is configured to slidably engage with at least one of the first rail and the second rail of said rail system or forms a waterproof pool liner configured to line the bed of the truck and to retain water therein.

15. The rack system of claim 1 further comprising a ladder that extends from the bed of the truck to a surface upon which tires of the truck are supported.

16. The rack system of claim 1 wherein the first end and the second end of at least said first support structure each have a set of rollers attached thereto that are configured to engage with said rail system for slidably positioning said first support structure within said rail system, and optionally, each set of rollers runs along a bottom of the first rail or the second rail and along a first side and second side of the first rail or the second rail to form a U-shape inside the first rail or the second rail.

17. The rack system of claim 16 wherein each set of rollers includes at least three rollers, wherein a first of the three rollers is configured to be positioned within the first rail or the second rail, a second of the three rollers is configured to be positioned along a first side of the first rail or the second rail, and a third of the three rollers is configured to be positioned along a second side of the first rail or the second rail.

18. The rack system of claim 1 wherein at least said first support structure includes a lock mechanism near its first end and second end configured to secure the position of said first support structure relative to said second support structure along a length of the first rail and the second rail, and optionally, the lock mechanism is actuated by a handle provided on at least said first support structure.

19. The rack system of claim 1 wherein the cross member of each of said support structures includes a roller or a winch fixed to the cross member of said second support structure, or a plurality of slide stops.

20. The rack system of claim 1 further comprising at least one tie down strap or bungie cord connected at a first end to each of said support structures, the at least one tie down strap or bungie cord extendable from each of said support structures.
